(19) United States
(12) Patent Application Publication
(10) Pub. No.: US 2025/0341890 A1
(43) Pub. Date: Nov. 6, 2025

(54) OPTIMIZING IMAGE RENDERING IN DISPLAY APPARATUS

(71) Applicant: Varjo Technologies Oy, Helsinki (FI)

(72) Inventors: Mikko Strandborg, Hangonkylä (FI); Ville Timonen, Helsinki (FI)

(73) Assignee: Varjo Technologies Oy, Helsinki (FI)

(21) Appl. No.: 18/654,084

(22) Filed: May 3, 2024

(51) Int. Cl. G06F 3/01; G06T 3/18; G06T 5/20; G06T 7/20; G06T 7/70

(52) U.S. Cl. CPC G06F 3/013; G06T 3/18; G06T 5/20; G06T 7/20; G06T 7/70; G06T 2207/30201

(57) ABSTRACT

Disclosed is a method of optimizing image rendering implemented in at least one display apparatus that includes predicting a pose and a first gaze location of a user for a display target time; rendering an image frame based on the predicted pose and the first gaze location; determining a second gaze location after rendering of the image frame; adjusting the rendered image frame such that an image area of the rendered image frame under the first gaze location and its surrounding region is moved to the second gaze location; and displaying the adjusted image frame on the at least one display apparatus.

### TECHNICAL FIELD

The present disclosure relates to a method of optimizing image rendering implemented in at least one display apparatus. Moreover, the present disclosure relates to a display apparatus having optimized power rendering.

### BACKGROUND

In the domain of extended reality (XR), virtual reality (VR), augmented reality (AR), and mixed reality (MR) head-mounted displays, one persistent problem is motion-to-photons latency. This latency, characterized by the delay between the head movement and image display, often leads to perceptible lag in visual feedback, causing discomfort such as dizziness and nausea for the users. Traditional methods to address this latency involve pose predictions and image warping techniques applied post-rendering but pre-display. These techniques, categorized into 3 degree of freedom (DOF), 6 DOF, and 9 DOF reprojection methods, attempt to adjust the displayed image to match the user's current head pose.

pose-based reprojection methods encounter several challenges. These include inaccuracies in pose prediction, potential disocclusion issues, and the need for accurate depth maps. Furthermore, errors may accumulate throughout the reprojection process, leading to suboptimal user experiences. Previous approaches to mitigating motion-to-photons latency primarily focus on adjusting rendered images based on the predicted head poses. These methods often require in-depth information and involve complex reprojection techniques to account for both rotational and translational head movements. However, challenges arise in accurately predicting pose changes and ensuring seamless image adjustments, leading to potential errors and discrepancies in the displayed content.

Therefore, in the light of the foregoing discussion, there exists a need to overcome the aforementioned drawbacks.

### SUMMARY

The aim of the present disclosure is to provide a method of optimizing image rendering implemented in at least one head-mounted display. The aim of the present disclosure is achieved by a method, as defined in the appended independent claims, which involve predicting a user's pose and gaze location, rendering an image frame based on the predicted pose and gaze location, adjusting the rendered image frame based on changes in gaze location, and displaying the adjusted image frame on the display apparatus. Advantageous features and additional implementations are set out in the appended dependent claims.

Embodiments of the present disclosure substantially eliminate or at least partially address the aforementioned problems in the prior art and enable generation of high-quality images with saccade-aware and optimized power consumption in the display apparatus.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 illustrates steps of a method for optimizing image rendering implemented in a display apparatus, in accordance with an embodiment of the present disclosure;

FIG. 2 is an illustration of a block diagram of a display apparatus configured for optimized image rendering, in accordance with an embodiment of the present disclosure; and

FIG. 3 is an illustration of an exemplary sequence diagram of events in a display apparatus for optimizing image rendering, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, the present disclosure provides a method of optimizing image rendering implemented in at least one display apparatus, the method comprising:
predicting a pose and a first gaze location of a user for a display target time;
rendering an image frame based on the predicted pose and the first gaze location;
determining a second gaze location after rendering of the image frame;
adjusting the rendered image frame such that an image area of the rendered image frame under the first gaze location and its surrounding region is moved to the second gaze location; and
displaying the adjusted image frame on the at least one display apparatus.

In a second aspect, the present disclosure provides a display apparatus comprising:
at least one processor configured to:
predict a pose and a first gaze location of a user for a display target time;
render an image frame based on the predicted pose and the first gaze location;
determine a second gaze location after rendering of the image frame;
adjust the rendered image frame such that an image area of the rendered image frame under the first gaze location and its surrounding region is moved to the second gaze location; and
display the adjusted image frame on the at least one display apparatus.

The present disclosure provides the aforementioned method of optimizing image rendering implemented in at least one display apparatus. By predicting the user's pose and gaze location, rendering the image frame based on these predictions, and subsequently adjusting the rendered image frame according to the actual gaze location, the method optimizes image rendering in real-time or near real-time. One key technical advantage is the prediction of both the user's pose and gaze location. This allows the display apparatus to anticipate where the user will be looking when the image frame is displayed, enabling proactive adjustments to the image frame before it is presented to the user. This predictive capability minimizes the need for reactionary adjustments, thereby reducing latency and improving synchronization between the user's movements and the displayed content. Furthermore, the method's ability to adjust the rendered image frame based on the changes in gaze location offers precise control over the visual content presented to the user. By moving the image area under the user's gaze to the correct location, the method ensures that the most relevant and visually important elements remain centred in the user's field of view. This targeted adjustment enhances immersion and engagement by maintaining the user's focus on critical areas of the scene. Additionally, the method's implementation on at least one display apparatus further enhances its technical advantages. By integrating the image rendering, gaze tracking, and display functions into a cohesive system, the method can be seamlessly deployed across various extended reality (XR), virtual reality (VR), augmented reality (AR), or mixed reality (MR) platforms, ensuring compatibility and scalability. This holistic approach streamlines the rendering process and optimizes resource utilization, leading to improved performance and efficiency. Overall, the technical advantage of the method lies in its ability to accurately predict, render, and adjust image frames based on the user's gaze behavior, thereby minimizing latency and enhancing the quality of the displayed content in XR/VR/AR/MR head-mounted displays.

Throughout the present disclosure, the term “optimizing image rendering” refers to the process of improving the efficiency and quality of displaying visual content on at least one display apparatus, particularly in XR/VR/AR/MR head-mounted displays. This optimization involves various techniques aimed at minimizing latency, enhancing image clarity, ensuring smooth transitions, and maximizing user immersion and comfort. Specifically, the term encompasses actions such as predicting poses and gaze locations of a user, rendering image frames based on these predictions, adjusting rendered frames to match actual gaze behavior, and displaying the adjusted frames on the display apparatus. The goal is to create a seamless and immersive visual experience for users while minimizing any delays or discrepancies between their movements and the displayed content.

Throughout the present disclosure, the term “display apparatus” refers to a specialized equipment that is capable of at least displaying a video stream. The video stream is to be presented to a user of the at least one display apparatus. It will be appreciated that the term “display apparatus” encompasses a head-mounted display (HMD) device and optionally, a computing device communicably coupled to the HMD device. The term “head-mounted display” device refers to a specialized equipment that is configured to present an extended-reality (XR) environment to a user when said HMD device, in operation, is worn by said user on his/her head. The HMD device is implemented, for example, as an XR headset, a pair of XR glasses, and the like, that is operable to display a visual scene of the XR environment to the user. Examples of the computing device include, but are not limited to, a laptop, a desktop, a tablet, a phablet, a personal digital assistant, a workstation, and a console. The term “extended-reality” encompasses virtual reality (VR), augmented reality (AR), mixed reality (MR), and the like. The at least one server could be remotely located from the at least one display apparatus.

Throughout the present disclosure, the term “saccadic movement” refers to a rapid movement of the user's eyes between two or more points of fixation within a field of view of said user. Typically, unless the user's eyes are actively following an object or its portion (namely, the user's eyes are in pursuit) or are adjusting for head movements (via a vestibulo-ocular reflex), the user's eyes are primarily engaged in discrete and rapid movements known as saccades. It will be appreciated that the saccades are ballistic in nature as a subsequent gaze position could be reasonably predicted, typically accurately within a few degrees during a beginning of a given saccade. The saccades are well-known in the art. The saccade is comprised in a gaze tracking data, wherein the gaze tracking data corresponds to a beginning of the saccade. Herein, the gaze tracking data may include images of the user's eyes, and the beginning of the saccade may be detected when certain features (for example, such as position of pupils) of the user's eyes, shift in the images of the user's eyes. The gaze tracking data is provided by one or more gaze cameras. Throughout the present disclosure, the term “gaze camera” refers to a specialized camera or sensor that is designed to track and monitor the direction of a person's gaze, or where they are looking. The gaze cameras are typically equipped with sensors and software that can accurately determine the position of a person's eyes, the movement of their gaze, and even the precise point in their field of vision they are focusing on.

Throughout the present disclosure, the term “pose” refers to the orientation and position of a user's head or body relative to a reference point or coordinate system. In the context of XR/VR/AR/MR head-mounted displays, pose typically includes parameters such as rotation (pitch, yaw, and roll) and translation (x, y, z coordinates) that describe the user's spatial orientation and location in the virtual environment.

Predicting the user's pose involves estimating these parameters at a specific point in time, often based on the sensor data or tracking systems integrated into the display apparatus. The predicted pose is then used to render visual content from the appropriate perspective, ensuring that the displayed imagery aligns with the user's viewpoint and movements.

Throughout the present disclosure, the term “pose-tracking data” refers to the information collected and processed by the display apparatus regarding the position and orientation of the user's head or body in the virtual environment. Pose-tracking data provides insights into the user's movements, including changes in position, rotation, and acceleration, which are essential for creating an immersive and interactive experience in extended reality (XR), virtual reality (VR), augmented reality (AR), or mixed reality (MR) applications.

Throughout the present disclosure, the term “first gaze location” refers to the predicted point in the user's field of view where their gaze is directed at a specific display target time. This prediction is based on various factors, including previous gaze behavior, head movement, and contextual information. The first gaze location serves as a reference point for rendering visual content, ensuring that the most relevant or important elements are presented prominently within the user's line of sight. By accurately predicting the user's gaze location, the display apparatus can optimize image rendering to enhance user engagement and immersion in XR/VR/AR/MR environments. Throughout the present disclosure, the term “gaze-tracking data” refers to the information collected and analysed by the display apparatus regarding the direction and movement of the user's gaze within the virtual environment. Gaze-tracking data provides insights into where the user is looking, how their gaze moves over time, and their visual focus within the displayed content.

Throughout the present disclosure, the term “user” refers to an individual who interacts with an XR/VR/AR/MR system, particularly through the use of a head-mounted display apparatus. The user may wear the display apparatus to immerse themselves in virtual environments, interact with virtual objects, or consume digital content. The term “user” encompasses individuals of various demographics, including but not limited to consumers, gamers, professionals, researchers, and educators, who engage with XR/VR/AR/MR technology for entertainment, training, simulation, communication, or other purposes.

Throughout the present disclosure, the term “real time” refers to the immediate or instantaneous processing and response of data within the system. In the context of the present disclosure, real-time operations involve minimal delay between the collection of input data, such as head and eye movements, and the system's corresponding adjustments or responses. Throughout the present disclosure, the term “near real time” refers to a processing capability that operates with minimal latency, typically on the order of milliseconds or seconds, allowing for rapid analysis and response to incoming data. While not instantaneous like real-time processing, near real-time operations still occur with minimal delay, enabling timely adjustments and interactions within the system.

Throughout the present disclosure, the term “display target time” refers to a specific moment in time when an image frame is intended to be displayed on at least one display apparatus, such as an XR/VR/AR/MR head-mounted display. This time point is determined based on various factors, including system latency, rendering pipeline timing, and synchronization requirements. The display target time serves as a reference for predicting the user's pose and gaze location, rendering the image frame accordingly, and adjusting it to match the user's actual gaze behavior. By aligning the rendering process with the display target time, the system aims to minimize latency and ensure that the displayed content remains synchronized with the user's movements and interactions in the virtual environment.

The pose and the first gaze location of the user can be predicted for the display target time. In an embodiment, the predicting of the pose and the first gaze location comprises analysing pose-tracking data and gaze-tracking data of the user wearing the at least one display apparatus wherein operation. In this regard, predicting the pose and the first gaze location of the user for the display target time involves a sophisticated analysis of pose-tracking and gaze-tracking data captured by sensors integrated into the display apparatus. The above mentioned sensors continuously monitor the user's movements and eye behavior while the user is wearing the display apparatus. The pose-tracking data provides insights into the user's head orientation and position, including rotations and translations, while the gaze-tracking data reveals the direction of the user's gaze within the display's field of view. To predict the user's pose and the first gaze location, advanced algorithms are applied to analyse and fuse these two types of data. Techniques such as Kalman filters or machine learning models may be employed to integrate the pose and gaze information, taking into account the user's recent movements, gaze patterns, and contextual cues. By leveraging this combined dataset, the display apparatus can anticipate how the user's head will be positioned and where their gaze will be directed at the specified display target time.

Throughout the present disclosure, the term “image frame” refers to a single still image or a frame of visual content intended to be displayed on at least one display apparatus, such as an XR/VR/AR/MR head-mounted display. An image frame represents a snapshot of a virtual environment or scene rendered by a computer graphics system. It comprises a two-dimensional array of pixels, each pixel containing color and depth information that collectively form the visual representation of the scene. In the context of the disclosed method, multiple image frames are rendered sequentially to create the illusion of motion, similar to traditional video playback. Each image frame is generated based on the predicted pose and the first gaze location of the user at a specific display target time. The content of the image frame may include virtual objects, environments, interfaces, or other visual elements designed to be viewed by the user. The term “image frame” is used interchangeably with terms such as “frame,” “visual frame,” or simply “frame” throughout the disclosure to refer to the individual units of visual content rendered and displayed on the head-mounted display apparatus. These frames collectively form the visual experience presented to the user in XR/VR/AR/MR environments.

Throughout the present disclosure, the term “second gaze location” refers to the updated or actual point in the user's field of view where their gaze is directed after the rendering of an image frame. Unlike the “first gaze location,” which is predicted for a specific display target time, the “second gaze location” is determined in real-time or near real-time after the image frame has been rendered and displayed on the at least one display apparatus. Determining the second gaze location after rendering of the image frame involves a real-time analysis of updated gaze-tracking data collected from the user wearing the display apparatus. Equipped with gaze-tracking sensors, such as eye-tracking cameras or infrared sensors, the display apparatus continuously monitors the user's eye movements and gaze direction. During the rendering process, the eye-tracking cameras or infrared sensors capture data on the user's gaze behavior as the sensors observe the displayed image frame, including fixation points and saccadic movements. The captured data is processed in real-time by sophisticated algorithms, leveraging computer vision techniques or machine learning models to identify the user's current gaze location within the displayed content. The determined second gaze location represents the updated point in the user's field of view where their gaze is directed after the image frame has been rendered. By accurately determining this gaze location, the display apparatus can adjust the rendered image frame to ensure that the most relevant content remains centred within the user's line of sight, thereby optimizing the user experience in XR/VR/AR/MR environments.

The rendered image frame is adjusted such that an image area of the rendered image frame under the first gaze location and its surrounding region is moved to the second gaze location. Here, the term “image area of the rendered image frame” refers to a specific region within the visual content of the rendered image frame. The above mentioned specific region encompasses the portion of the image frame that corresponds to the user's predicted or actual gaze location at a given point in time. In an implementation, the image area under consideration is the area of the rendered image frame that is located at or near the user's first gaze location or second gaze location. The image area serves as the focal point of the user's attention within the displayed visual content. The term “image area” encompasses a subset of pixels within the overall image frame, defined by its spatial coordinates and dimensions. The image area may vary in size and shape depending on factors such as the user's gaze behavior, the complexity of the visual scene, and the display apparatus's field of view. By identifying and manipulating the specific image area, the display apparatus may adjust the rendering of the image frame to ensure that the content of interest remains prominently displayed within the user's field of view. The technical effect of the abovementioned targeted adjustment is to enhance the user's visual experience by dynamically aligning the displayed content with their gaze behavior and attentional focus in XR/VR/AR/MR environments.

In another embodiment, the adjusting of the rendered image frame comprises warping the rendered image frame and filtering saccadic movements of eyes of the user from the warping. In this regard, the warping process modifies the geometry or appearance of the rendered image frame to align it with the user's gaze location, ensuring that the focal point of the displayed content remains in sync with the user's current visual focus. Simultaneously, the filtering mechanism selectively attenuates or suppresses rapid eye movements known as saccades, which can introduce visual distortions and artifacts if not properly addressed. The technical effect of warping the rendered image frame and filtering saccadic movements of the user's eyes is to enhance the visual stability and quality of the displayed content. By seamlessly adjusting the image frame to match the user's gaze location while filtering out saccadic movements, the system provides a smoother, more natural, and immersive viewing experience within XR/VR/AR/MR environments.

In yet another embodiment, the adjusting of the rendered image comprises warping the rendered image frame, wherein the image area corresponds a focus region of the rendered image frame that is moved from the first gaze location to the second gaze location to match the user's actual gaze direction in the real-time or the near real-time. In this regard, the method utilizes advanced operations that analyse the user's gaze data and dynamically adjust the position of the focus region within the rendered image frame. Specifically, the method continuously tracks the user's eye movements and updates the position of the focus region based on the real-time or near real-time gaze data. By applying mathematical transformations to the image coordinates, the method seamlessly shifts the focus region to align with the user's current gaze direction. The technical effect of this warping process is to create a visually coherent and responsive display that reflects the user's gaze behavior in the virtual environment. By ensuring that the focus region of the image frame accurately corresponds to the user's actual gaze location, the method enhances the sense of immersion and realism, allowing users to interact with the virtual content more intuitively and naturally.

In yet another embodiment, the adjusting of the rendered image frame comprises warping the rendered image frame, wherein the image area corresponds to an entire area of the image frame that is moved from the first gaze location to the second gaze location to match the user's actual gaze direction in a real-time or near real-time at the time of displaying. In this regard, the method employs real-time or near real-time gaze-tracking data to precisely determine the user's current gaze location. Based on this information, the method dynamically adjusts the entire image frame, ensuring that it accurately aligns with the user's gaze direction at the moment of display. This adjustment involves applying mathematical transformations to the entire image frame, shifting it to match the user's visual focus area. The technical effect of this warping process is to optimize the displayed content to align with the user's immediate visual attention, enhancing the overall viewing experience. By dynamically adjusting the entire image frame based on the user's real-time gaze direction, the method maximizes the relevance and immersion of the displayed content, improving user engagement and interaction within the virtual environment.

Throughout the present disclosure, the term “pose delta” refers to the difference or change in the predicted pose of the user's head between different time intervals. Specifically, the pose delta represents the variation in the orientation and position of the user's head from one predicted timepoint to another, typically measured in terms of rotational angles and translational distances.

In yet another embodiment, the adjusting of the rendered image frame comprises warping the rendered image frame without considering a pose delta that corresponds to any changes in the pose predicted at a first time to a subsequent second time, a subsequent third, a subsequent fourth, or a subsequent fifth time, wherein the first time is a timepoint at which the pose and the first gaze location of the user is predicted, the subsequent second time is a time interval for which the image frame is rendered, the subsequent third time is a timepoint at which the second gaze location is determined, the subsequent fourth time is a timepoint at which the rendered image frame is adjusted, and the subsequent fifth time is a timepoint at which the adjusted image frame is displayed. In this regard, by ignoring pose deltas between the initial prediction time and subsequent intervals, the method simplifies the adjustment process of the rendered image frame. This approach reduces computational complexity and processing overhead associated with continuously updating the image frame based on predicted pose changes. Consequently, the method achieves improved efficiency and responsiveness in adjusting the image frame to match the user's gaze direction, contributing to a smoother and more seamless visual experience within the virtual environment. The technical effect of this approach is to streamline the rendering and adjustment process of the image frame, leading to enhanced performance and reduced latency in displaying content to the user. By optimizing the utilization of computational resources and minimizing processing delays, the method ensures a more responsive and immersive viewing experience, ultimately improving user satisfaction and engagement in XR/VR/AR/MR applications.

The adjusted image frame can be displayed on the at least one display apparatus. The technical effect of displaying the adjusted image frame on the at least one display apparatus is to provide users with an immersive and seamless viewing experience within the XR/VR/AR/MR environment. By presenting the adjusted image frame, which accurately aligns with the user's gaze direction, the display apparatus enhances visual clarity and engagement with the displayed content. The displayed adjusted image frame ensures that the focal point of the content remains synchronized with the user's current gaze location, promoting a more natural and intuitive interaction with virtual objects and environments. This alignment facilitates smoother transitions between different visual elements and enhances the overall realism of the virtual experience.

Additionally, by showcasing the adjusted image frame without perceptible delays, the display apparatus minimizes motion-to-photons latency, reducing the likelihood of motion sickness or discomfort for users. This contributes to a more comfortable and enjoyable viewing experience, fostering greater immersion and presence within the virtual environment.

Throughout the present disclosure, the term “degree of freedom warping” refers to the process of adjusting the rendered image frame based on a specified number of degrees of freedom, which typically represent rotational or translational movements in the virtual environment. This technique allows for the manipulation of the image frame's geometry or appearance to align with the user's gaze direction, providing a more immersive and responsive visual experience within XR/VR/AR/MR applications. Throughout the present disclosure, the term “reprojection operation” refers to a computational process used to adjust the rendered image frame based on changes in the user's gaze direction or head pose. In this operation, the original image frame undergoes a re-projection onto a new virtual viewpoint, typically determined by the updated gaze location or head pose data. The reprojected image is then displayed to the user, giving the illusion that the virtual scene has been rendered from the new viewpoint. The reprojection operation allows for seamless adjustments to the displayed content, ensuring that the displayed content remains aligned with the user's visual focus and enhancing the overall realism and immersion of the XR/VR/AR/MR experience.

In yet another embodiment, the image area of the image frame under the first gaze location and its surrounding region is moved to the second gaze location using at least one of: a 3 degrees of freedom (DOF) warping, a 6 DOF warping, a 9 DOF warping, a reprojection operation, or a combination thereof. In this regard, the method involves applying mathematical transformations to the rendered image frame to adjust its appearance or geometry based on the user's gaze behavior. The specific warping technique utilized, whether it's 3 DOF, 6 DOF, or 9 DOF, determines the extent and complexity of the adjustments made to the image frame. Additionally, the method may incorporate the reprojection operation, which involves re-rendering the image frame to align the image frame with the user's current gaze location. The technical effect of employing different warping techniques is to enhance the accuracy and responsiveness of the visual rendering process in XR/VR/AR/MR environments. By selecting the appropriate warping method based on the desired level of precision and the available input data (such as pose and gaze-tracking data), the method ensures that the displayed content closely reflects the user's gaze behavior. By closely reflecting the user's gaze behaviour by the displayed content, a more immersive and realistic viewing experience is achieved, where virtual objects and environments seamlessly respond to the user's visual attention, thereby improving user engagement and satisfaction.

Throughout the present disclosure, the term “motion vector” refers to a direction and magnitude of movement for specific regions within an image or video sequence. In the context of the present disclosure, motion vectors related to a gaze location indicate the velocity and direction of movement of objects or regions within the displayed content, as perceived by the user's gaze. The motion vectors are typically extracted through computational analysis of consecutive image frames and are used to track the motion of objects or features of interest in the visual scene. Throughout the present disclosure, the term “gaze delta” refers to a change or displacement in the user's gaze location between two successive instances or timepoints. In the context of the present disclosure, the gaze delta is calculated as the difference between the initial gaze location (the first gaze location) and the subsequent gaze location (the second gaze location) of the user. The gaze delta provides a measure of the movement or shift in the user's visual focus within the displayed content over a specific time interval. Comparing the gaze delta with other parameters, such as motion vectors, helps to determine the nature of the user's gaze behavior, such as smooth pursuit tracking of a moving object or fixation on a stationary point.

In yet another embodiment, the method further comprising:
extracting motion vectors related to a gaze location, wherein the motion vectors indicate movement of an image region from one image frame to a next image frame;
comparing a gaze delta indicative of a change between the first gaze location and the second gaze location of the user with the extracted motion vectors; and
determine if the user's gaze is in smooth pursuit tracking of a moving object based on the comparison.

In this regard, the motion vectors related to the gaze location are extracted to discern the movement of an image region from one frame to the next. By comparing the gaze delta, indicative of the change between the initial and subsequent gaze locations, with the extracted motion vectors, the method determines if the user's gaze is engaged in smooth pursuit tracking of a moving object. The technical effect of this process is to refine the rendering optimization by accurately identifying the user's gaze behavior in relation to moving objects within the displayed content. By leveraging motion vectors and comparing them with gaze deltas, the method enhances the system's ability to distinguish between smooth pursuit tracking and other gaze movements, such as saccades or fixations. This distinction allows for precise adjustments in rendering, ensuring that the displayed content aligns seamlessly with the user's visual attention. Ultimately, this contributes to an improved XR/VR/AR/MR experience characterized by enhanced realism and user engagement.

In yet another embodiment, the method further comprising refraining from warping the image frame if the gaze delta aligns with the motion vectors and the image frame is displayed at or near the target display time. In this regard, when the gaze delta aligns with the motion vectors and the image frame is displayed at or near the target display time, refraining from warping the image frame ensures that unnecessary adjustments are avoided. This strategy optimizes the rendering process by conserving computational resources and minimizing distortion to the displayed content. The technical effect of this approach lies in its ability to enhance the efficiency and responsiveness of the XR/VR/AR/MR system. By leveraging the alignment between gaze movement and motion vectors, coupled with accurate timing considerations, the method significantly reduces computational overhead and latency, resulting in a smoother and more immersive user experience.

In yet another embodiment, the image frame is a video-see-through (VST) image frame. In the context of the present disclosure, a “video-see-through (VST) image frame” refers to a specific type of image frame utilized in mixed reality (MR) systems. Unlike other types of image frames, VST image frames are generated by capturing real-time video footage of the user's physical surroundings using external cameras or sensors. This video stream is then processed and augmented with virtual or digital content, such as computer-generated graphics, overlays, or holograms, to create an integrated mixed reality experience for the user. The VST image frames are particularly useful in MR applications because they enable users to perceive and interact with virtual objects or elements within their actual physical environment. By seamlessly blending virtual content with real-world surroundings in real-time, VST image frames provide users with a highly immersive and engaging mixed reality experience. Users can see and interact with virtual objects as if they were part of their immediate environment, enhancing the sense of presence and realism in the MR environment. The technical effect of utilizing the VST image frames lies in their ability to facilitate accurate spatial mapping and alignment of virtual content with the user's physical surroundings. By leveraging real-time video streams of the environment, MR systems can dynamically adjust virtual elements based on changes in the user's viewpoint or movement, ensuring seamless integration and interaction between the virtual and real-world environments. This results in a more immersive and interactive MR experience, enhancing user engagement and usability across a wide range of applications, from gaming and entertainment to education and training.

Beneficially, the method of optimizing image rendering, as depicted in the illustrated sequence diagram, provides a seamless and immersive user experience by dynamically adjusting the rendered image frame to match the user's actual gaze location. By accurately predicting the user's pose and gaze location, and subsequently adjusting the image frame accordingly, the method ensures that the area of the image frame under the user's focus remains aligned with their gaze. This enhances the realism and precision of the displayed content, allowing users to interact with virtual elements in a natural and intuitive manner. Additionally, by incorporating real-time adjustments based on the user's gaze, the method minimizes motion-to-photons latency, reducing the risk of motion sickness and enhancing overall comfort during extended use of XR/VR/AR/MR head-mounted displays.

The present disclosure also relates to the second aspect as described above. Various embodiments and variants disclosed above, with respect to the aforementioned first aspect apply mutatis mutandis to the second aspect.

In this regard, throughout the present disclosure, the term “at least one processor” refers to a processor that is configured to control an overall operation of the display apparatus and to implement the processing steps. Examples of implementation of the at least one of processor may include, but are not limited to, a central data processing device, a microprocessor, a microcontroller, a complex instruction set computing (CISC) processor, an application-specific integrated circuit (ASIC) processor, a reduced instruction set (RISC) processor, a very long instruction word (VLIW) processor, a state machine, and other processors or control circuitry. Optionally, the at least one of processor is communicably coupled to a display of the display apparatus. In some implementations, the processor of the display apparatus, through an application, is configured to render the one or more frames. In some implementations, the processor of the display apparatus, through the display, is configured to display the one or more rendered frames.

Optionally, in order to predict the pose and the first gaze location, the at least one processor is further configured to analyse pose-tracking data and gaze-tracking data of the user wearing the at least one display apparatus when in operation.

Optionally, in order to adjust the rendered image frame, the at least one processor is further configured to warp the rendered image frame and filter saccadic movements of eyes of the user from the warping.

Optionally, in order to adjust the rendered image, the at least one processor is further configured to warp the rendered image frame, wherein the image area corresponds a focus region of the rendered image frame that is moved from the first gaze location to the second gaze location to match the user's actual gaze direction in a real-time or near real-time.

Optionally, in order to adjust the rendered image, the at least one processor is further configured to warp the rendered image frame, wherein the image area corresponds to an entire area of the image frame that is moved from the first gaze location to the second gaze location to match the user's actual gaze direction in a real-time or near real-time at the time of displaying.

### DETAILED DESCRIPTION OF THE DRAWINGS

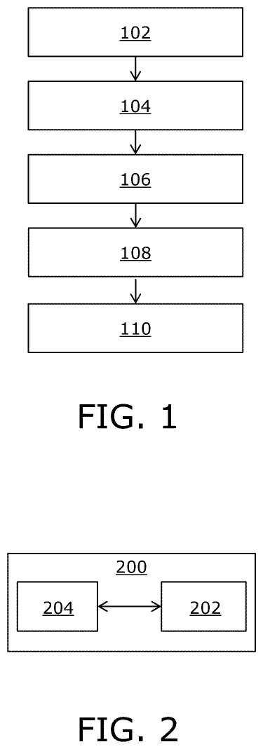

Referring to FIG. 1, illustrated are steps of a method for optimizing image rendering in at least one display apparatus, in accordance with an embodiment of the present disclosure. The method is implemented by the at least one display apparatus. At step 102, a pose and a first gaze location of a user is predicted for a display target time. At step 104, an image frame is rendered based on the predicted pose and the first gaze location. At step 106, a second gaze location is determined after rendering of the image frame. At step 108, the rendered image frame is adjusted such that an image area of the rendered image frame under the first gaze location and its surrounding region is moved to the second gaze location. At step 110, the adjusted image frame is displayed on the at least one display apparatus.

The aforementioned steps are only illustrative, and other alternatives can also be provided where one or more steps are added, one or more steps are removed, or one or more steps are provided in a different sequence without departing from the scope of the claims herein.

Referring to FIG. 2, illustrated is a block diagram of a display apparatus 200 configured for optimized image rendering, in accordance with an embodiment of the present disclosure. The display apparatus 200 includes at least one processor (depicted as a processor 202). Optionally, the display apparatus 200 further comprises a display 204, wherein the processor 202 is communicably coupled to the display 204. The processor 202 is configured to perform various operations as described earlier with respect to the aforementioned second aspect. Optionally, the display 204 is configured to display the rendered image frame that is adjusted such that an image area of the rendered image frame under the first gaze location and its surrounding region is moved to the second gaze location.

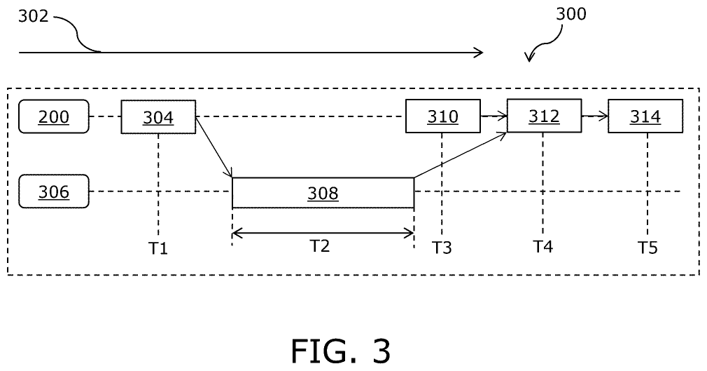

Referring to FIG. 3, illustrated is an exemplary sequence diagram of events in the display apparatus 200 (of FIG. 2) for optimizing image rendering, in accordance with an embodiment of the present disclosure. The sequence diagram 300 outlines the steps involved in predicting the user's pose and gaze location, rendering the image frame based on the predicted parameters, determining the second gaze location, adjusting the rendered image frame accordingly, and finally displaying the adjusted image frame on the display apparatus. Each step in the sequence diagram 300 represents a specific action or process within the image rendering optimization workflow, illustrating the flow of data and operations within the display apparatus to achieve efficient and accurate rendering of images in real-time or near real-time. There is further shown a time axis 302 that depicts the flow of events with respect to time. At 304, the pose and the first gaze location of the user is predicted for the first time T1, i.e., the display target time. The sequence diagram 300 further includes a rendering application 306 configured to render the one or more image frames at 308 for the subsequent second time T2. At 310, the display apparatus 200 determines the second gaze location after rendering the one or more image frames. Further, the second gaze location is determined at the subsequent third time T3. After that, at 312, the display apparatus 200 adjusts the rendered image frame, at the subsequent fourth time T4, such that the image area of the rendered image frame under the first gaze location and its surrounding region is moved to the second gaze location. Lastly, at 314, the display apparatus 200 displays the adjusted image frame on the display 204 (shown in FIG. 2) at the subsequent fifth time T5.

FIG. 3 is merely an example, which should not unduly limit the scope of the claims herein. A person skilled in the art will recognize many variations, alternatives, and modifications of embodiments of the present disclosure.

1. A method of optimizing image rendering implemented in at least one display apparatus, the method comprising:
predicting a pose and a first gaze location of a user for a display target time;
rendering an image frame based on the predicted pose and the first gaze location;
determining a second gaze location after rendering of the image frame;
adjusting the rendered image frame such that an image area of the rendered image frame under the first gaze location and its surrounding region is moved to the second gaze location; and
displaying the adjusted image frame on the at least one display apparatus.

2. The method of claim 1, wherein the predicting of the pose and the first gaze location comprises analysing pose-tracking data and gaze-tracking data of the user wearing the at least one display apparatus when in operation.

3. The method of claim 1, wherein the adjusting of the rendered image frame comprises warping the rendered image frame and filtering saccadic movements of eyes of the user from the warping.

4. The method of claim 1, wherein the adjusting of the rendered image comprises warping the rendered image frame, wherein the image area corresponds a focus region of the rendered image frame that is moved from the first gaze location to the second gaze location to match the user's actual gaze direction in a real-time or near real-time.

5. The method of claim 1, wherein the adjusting of the rendered image frame comprises warping the rendered image frame, wherein the image area corresponds to an entire area of the image frame that is moved from the first gaze location to the second gaze location to match the user's actual gaze direction in a real-time or near real-time at the time of displaying.

6. The method of claim 1, wherein the adjusting of the rendered image frame comprises warping the rendered image frame without considering a pose delta that corresponds to any changes in the pose predicted at a first time to a subsequent second time, a subsequent third, a subsequent fourth, or a subsequent fifth time, wherein the first time is a timepoint at which the pose and the first gaze location of the user is predicted, the subsequent second time is a time interval for which the image frame is rendered, the subsequent third time is a timepoint at which the second gaze location is determined, the subsequent fourth time is a timepoint at which the rendered image frame is adjusted, and the subsequent fifth time is a timepoint at which the adjusted image frame is displayed.

7. The method of claim 1, wherein the image area of the image frame under the first gaze location and its surrounding region is moved to the second gaze location using at least one of: a 3 degrees of freedom (DOF) warping, a 6 DOF warping, a 9 DOF warping, a reprojection operation, or a combination thereof.

8. The method of claim 1, further comprising:
extracting motion vectors related to a gaze location, wherein the motion vectors indicate movement of an image region from one image frame to a next image frame;
comparing a gaze delta indicative of a change between the first gaze location and the second gaze location of the user with the extracted motion vectors; and
determine if the user's gaze is in smooth pursuit tracking of a moving object based on the comparison.

9. The method of claim 8, further comprising refraining from warping the image frame if the gaze delta aligns with the motion vectors and the image frame is displayed at or near the target display time.

10. The method of claim 1, wherein the image frame is a video-see-through (VST) image frame.

11. A display apparatus comprising:
at least one processor configured to:
predict a pose and a first gaze location of a user for a display target time;
render an image frame based on the predicted pose and the first gaze location;
determine a second gaze location after rendering of the image frame;
adjust the rendered image frame such that an image area of the rendered image frame under the first gaze location and its surrounding region is moved to the second gaze location; and
display the adjusted image frame on the at least one display apparatus.

12. The display apparatus of claim 11, wherein in order to predict the pose and the first gaze location, the at least one processor is further configured to analyse pose-tracking data and gaze-tracking data of the user wearing the at least one display apparatus when in operation.

13. The display apparatus of claim 11, wherein in order to adjust the rendered image frame, the at least one processor is further configured to warp the rendered image frame and filter saccadic movements of eyes of the user from the warping.

14. The display apparatus of claim 11, wherein in order to adjust the rendered image, the at least one processor is further configured to warp the rendered image frame, wherein the image area corresponds a focus region of the rendered image frame that is moved from the first gaze location to the second gaze location to match the user's actual gaze direction in a real-time or near real-time.

15. The display apparatus of claim 11, wherein in order to adjust the rendered image, the at least one processor is further configured to warp the rendered image frame, wherein the image area corresponds to an entire area of the image frame that is moved from the first gaze location to the second gaze location to match the user's actual gaze direction in a real-time or near real-time at the time of displaying.
